(19) United States
(12) Patent Application Publication
(10) Pub. No.: US 2025/0373090 A1
(43) Pub. Date: Dec. 4, 2025

(54) ROTARY ELECTRIC MACHINE

(71) Applicant: DENSO CORPORATION, Kariya-city (JP)

(72) Inventor: YU KUWAHARA, Kariya-city (JP)

(21) Appl. No.: 19/299,114

(22) Filed: Aug. 13, 2025

Related U.S. Application Data
(63) Continuation of application No. PCT/JP2024/003608, filed on Feb. 5, 2024.

(30) Foreign Application Priority Data
Feb. 17, 2023 (JP) 2023-023237

(51) Int. Cl. H02K 1/14; H02K 1/2793; H02K 3/14; H02K 3/28; H02K 3/34; H02K 9/22

(52) U.S. Cl. CPC H02K 1/14; H02K 1/2793; H02K 3/14; H02K 3/28; H02K 3/345; H02K 9/22; H02K 2203/06

(57) ABSTRACT

A rotary electric machine is driven by a supply of electric power. The rotary electric machine includes a stator and a rotor. The stator includes a coil portion having coil wires. The rotor rotates about a rotation axis and faces the stator along the rotation axis. The coil portion includes a wire body that has a wire shape in which the coil wires are twisted together. The wire body has an outer peripheral surface formed by the coil wires, and is wound to be stacked along the rotation axis.

### CROSS REFERENCE TO RELATED APPLICATIONS

The present application is a continuation application of International Patent Application No. PCT/JP2024/003608 filed on Feb. 5, 2024, which designated the U.S. and claims the benefit of priority from Japanese Patent Application No. 2023-023237 filed on Feb. 17, 2023. The disclosures of all the above applications are incorporated herein.

### TECHNICAL FIELD

The disclosure in this specification relates to a rotary electric machine.

### BACKGROUND ART

In an axial gap motor, a rotor and a stator are aligned in an axial direction. The stator has a coil formed from two rectangular wires. In this coil, the two rectangular wires are wound to be arranged side by side in the radial direction of the coil.

### SUMMARY

According to an aspect of the present disclosure, a rotary electric machine is configured to be driven by a supply of electric power. The rotary electric machine includes a stator and a rotor. The stator includes a coil portion having coil wires. The rotor is configured to rotate about a rotation axis and faces the stator along the rotation axis. The coil portion includes a wire body that has a wire shape in which the coil wires are twisted together. The wire body has an outer peripheral surface formed by the coil wires, and is wound to be stacked along the rotation axis.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a diagram illustrating a configuration of an eVTOL according to a first embodiment.

FIG. 2 is a diagram illustrating an electrical configuration of a propulsion system.

FIG. 3 is a schematic perspective view of an EPU.

FIG. 4 is a vertical cross-sectional view of a motor device.

FIG. 5 is a top view of a coil unit and a motor housing.

FIG. 6 is a schematic vertical cross-sectional view of the motor device.

FIG. 7 is a schematic top view of a coil portion illustrating an example of a coil wire.

FIG. 8 is a schematic top view of a coil portion illustrating a comparative outer circumferential wire and a comparative inner circumferential wire according to a comparative example.

FIG. 9 is a diagram illustrating an electrical configuration of the coil portion.

FIG. 10 is a schematic top view of the coil portion illustrating an enlarged coil wire portion.

FIG. 11 is a schematic side view of the coil portion illustrating the enlarged coil wire portion on an inner peripheral side of the coil.

FIG. 12 is a cross-sectional view taken along a line XII-XII in FIG. 8, and is a longitudinal cross-sectional view of the coil wire portion.

FIG. 13 is a longitudinal cross-sectional view of a coil wire portion according to a second embodiment.

FIG. 14 is a longitudinal cross-sectional view of a coil wire portion according to a third embodiment.

### DETAILED DESCRIPTION

According to a comparative example, an axial gap motor includes a rotor and a stator aligned in an axial direction. The stator has a coil formed from two rectangular wires. In this coil, the two rectangular wires are wound to be arranged side by side in the radial direction of the coil.

However, in the comparative example, a loss due to linkage magnetic flux is likely to increase in an inner rectangular wire of the two rectangular wires. Thus, a loss may increase in the coil.

In contrast, according to the present disclosure, a rotary electric machine is capable of reducing a loss in a coil portion.

According to a disclosed aspect, a rotary electric machine is configured to be driven by a supply of electric power. The rotary electric machine includes a stator and a rotor. The stator includes a coil portion having coil wires. The rotor is configured to rotate about a rotation axis and faces the stator along the rotation axis. The coil portion includes a wire body that has a wire shape in which the coil wires are twisted together. The wire body has an outer peripheral surface formed by the coil wires, and is wound to be stacked along the rotation axis.

According to the above aspect, the wire body constituting the coil portion is formed into a wire shape by twisting the coil wires together. In this configuration, when the position in a circumferential direction of the coil portion changes, the coil wires are shifted inward of the coil portion one by one while being switched in position. Therefore, it is possible to avoid an increase in loss due to linkage magnetic flux in a particular coil wire arranged on an inner side of the coil portion. Therefore, loss in the coil portion can be reduced.

Moreover, the outer peripheral surface of the wire body is formed by the coil wires. In this configuration, there is no need to provide the wire body with a coating that collectively covers the coil wires. Therefore, since there is no coating that collectively covers the coil wires, a space factor of the coil portion can be increased. Therefore, the loss in the coil portion can be further reduced.

Hereinafter, embodiments for implementing the present disclosure are described referring to drawings. In each embodiment, the same reference numerals may be given to parts corresponding to matters described in a preceding embodiment, and overlapping explanations may be omitted. When only a part of a configuration is described in an embodiment, the other preceding embodiments can be applied to the other parts of the configuration. It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

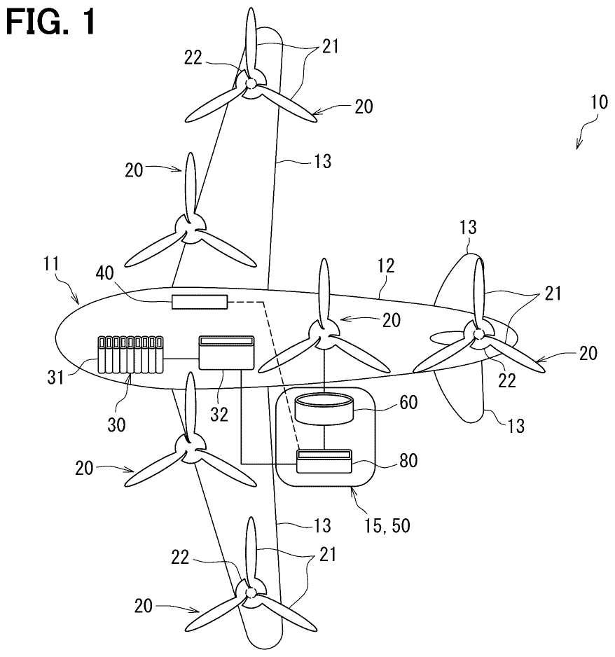

A propulsion system 30 shown in FIG. 1 is mounted in an eVTOL 10. The eVTOL 10 is an electric vertical take-off and landing aircraft, and can take off and land in a vertical direction. The eVTOL is an abbreviation of an electric vertical take-off and landing aircraft. The eVTOL 10 is an aircraft flying in the atmosphere and corresponds to a flight vehicle. The eVTOL 10 is also an electric-type electric aircraft and may be referred to as an electric flight vehicle. The eVTOL 10 is a manned aircraft carrying occupants. The propulsion system 30 is a system that drives the eVTOL 10 to fly.

The eVTOL 10 includes an airframe 11 and propellers 20. The airframe 11 includes an airframe main body 12 and wings 13. The airframe main body 12 is a body of the airframe 11 and has, for example, a shape extending in a front-rear direction. The airframe main body 12 has a passenger compartment for carrying occupants. Each of the wings 13 extends from the airframe main body 12 and multiple wings 13 are provided on the airframe main body 12. The wings 13 are fixed wings. The multiple wings 13 include a main wing, a tail wing, and the like.

The propellers 20 are provided on the airframe 11. The eVTOL 10 is a multicopter including at least three propellers 20. For example, at least four propellers 20 are provided on the airframe 11. The propellers 20 are provided on the airframe main body 12 and the wings 13. Each of the propellers 20 rotates around a propeller axis. The propeller axis is, for example, a center axis of a propeller 20. The propellers 20 can generate thrust and lift in the eVTOL 10. The propellers 20 may be referred to as rotors or rotary wings.

Each of the propellers 20 includes blades 21 and a boss 22. The blades 21 are arranged in a circumferential direction of the propeller axis. The boss 22 couples the multiple blades 21. Each of the blades 21 extends from the boss 22 in a radial direction of the propeller axis. Each of the propellers 20 includes a propeller shaft (not shown). The propeller shaft is a rotary shaft of each propeller 20 and extends along the propeller axis from the boss 22.

The eVTOL 10 is a tilt-rotor aircraft. In the eVTOL 10, tilt angles of the propellers 20 are adjustable. The eVTOL 10 may not be a tilt-rotor aircraft. For example, the eVTOL 10 may include lift-propellers 20 and cruise-propellers 20 which are separated.

The eVTOL 10 includes a battery 31, a distributor 32, a flight control device 40, and EPUs 50. The battery 31, the distributor 32, the flight control device 40, and the EPUs 50 are included in the propulsion system 30. The battery 31 is electrically connected to the EPUs 50. The battery 31 is a power supplying unit that supplies electric power to the EPUs 50, and corresponds to a power supply unit. The battery 31 is a DC voltage source that applies a direct-current voltage to the EPUs 50. The battery 31 has a rechargeable secondary battery. The battery 31 also supplies electric power to the flight control device 40. In addition to or instead of the battery 31, a fuel cell, a generator, or the like may be used as the power supply unit.

The distributor 32 is electrically connected to the battery 31 and the EPUs 50. The distributor 32 distributes the electric power from the battery 31 to the EPUs 50. The electric power distributed to the EPUs 50 by the distributor 32 is drive power for driving the EPUs 50.

The flight control device 40 controls the propulsion system 30. The flight control device 40 performs flight control for causing the eVTOL 10 to fly. The flight control device 40 is communicably connected to the EPUs 50. The flight control device 40 individually controls the EPUs 50. The flight control device 40 controls the EPUs 50 via a control circuit 160 to be described later. The flight control device 40 controls the control circuit 160.

Each of the EPUs 50 is a device for driving the propellers 20 to rotate, and corresponds to a drive device. EPU is an abbreviation of an electric propulsion unit. The EPUs 50 may be referred to as a power drive device or a power drive system. The EPUs 50 are provided individually for each of the propellers 20. The EPUs 50 are arranged on the propellers 20 along their propeller axes. All of the EPUs 50 are fixed on the airframe 11. The EPUs 50 rotatably support the propellers 20. The EPUs 50 are connected to the propellers 20. The propellers 20 are fixed to the airframe 11 via the EPUs 50. When the tilt angles of the propellers 20 are changed, angles of the EPUs 50 are also changed.

The eVTOL 10 includes propulsion devices 15. The propulsion devices 15 are devices for propelling the eVTOL 10. The eVTOL 10 can fly, such as lift, by propulsion of the propulsion devices 15. The propulsion devices 15 includes the propellers 20 and the EPUs 50. In the propulsion devices 15, the EPUs 50 are driven to rotate the propellers 20. The propellers 20 corresponds to a rotary body. The eVTOL 10 flies by rotating the propellers 20. That is, the eVTOL 10 moves by rotating the propellers 20. The eVTOL 10 corresponds to a moving object.

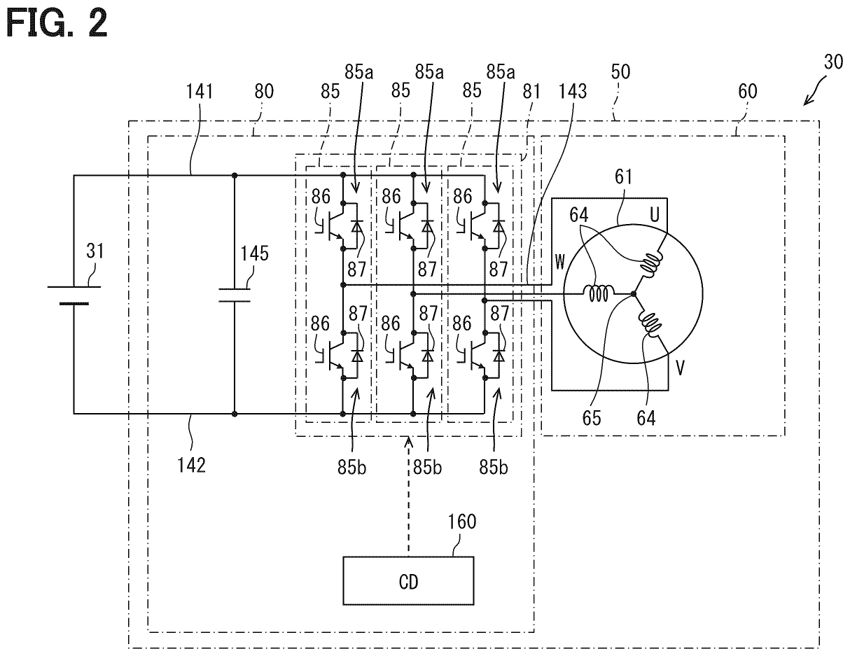

As shown in FIGS. 1 and 2, each of the EPUs 50 includes a motor device 60 and an inverter device 80. The motor device 60 includes a motor 61. The motor device 60 corresponds to a rotary electric machine. The inverter device 80 includes an inverter 81. The motor 61 is electrically connected to the battery 31 via the inverter 81. The motor 61 is driven in response to the electric power supplied from the battery 31 via the inverter 81.

The motor 61 is a multi-phase alternating-current motor. The motor 61 is, for example, a three-phase alternating-current motor, and has a U-phase, a V-phase, and a W-phase. The motor 61 is a movement driving source for moving the moving object, and functions as an electric motor. As the motor 61, for example, a brushless motor is used. The motor 61 functions as a generator during regeneration. The motor 61 includes coils 64 of multiple phases. The coils 64 are windings and form an armature. The coils 64 are provided for each of the U-phase, the V-phase, and the W-phase. In the motor 61, the coils 64 of multiple phases are connected to one another by a neutral point 65.

In FIG. 2, the inverter 81 drives the motor 61 by converting the electric power to be supplied to the motor 61. The inverter 81 converts the electric power supplied to the motor 61 from a direct current to an alternating current. The inverter 81 is a power conversion unit that converts the electric power. The inverter 81 is a multi-phase power conversion unit, and performs power conversion for each of the multiple phases. The inverter 81 is, for example, a three-phase inverter, and performs power conversion for each of the U-phase, the V-phase, and the W-phase. The inverter device 80 may be referred to as a power conversion device.

The inverter device 80 includes a P-line 141 and an N-line 142. The P-line 141 and the N-line 142 electrically connect the battery 31 and the inverter 81. The P-line 141 is electrically connected to a positive electrode of the battery 31. The N-line 142 is electrically connected to a negative electrode of the battery 31. In the battery 31, the positive electrode is an electrode on a high potential side, and the negative electrode is an electrode on a low potential side. The P-line 141 and the N-line 142 are power lines for supplying electric power. The P-line 141 is a power line on the high potential side and may be referred to as a high potential line. The N-line 142 is a power line on the low potential side and may be referred to as a low potential line.

Each of the EPUs 50 includes output lines 143. Each of the output lines 143 is a power line for supplying electric power to the motor 61. The output lines 143 electrically connect the motor 61 and the inverter 81. The output line 143 connects the motor device 60 and the inverter device 80.

The inverter device 80 includes a smoothing capacitor 145. The smoothing capacitor 145 is a capacitor that smooths the direct-current voltage supplied from the battery 31. The smoothing capacitor 145 is connected to the P-line 141 and the N-line 142 between the battery 31 and the inverter 81. The smoothing capacitor 145 is connected in parallel to the inverter 81.

The inverter 81 is a power conversion circuit, for example, a DC-AC conversion circuit. The inverter 81 includes upper and lower arm circuits 85 corresponding to the multiple phases. For example, the inverter 81 includes the upper and lower arm circuits 85 respectively for the U-phase, the V-phase, and the W-phase. Each of the upper and lower arm circuits 85 includes an upper arm 85a and a lower arm 85b. The upper arm 85a and the lower arm 85b are connected in series to the battery 31. The upper arm 85a is connected to the P line 141, and the lower arm 85b is connected to the N line 142.

The output lines 143 are connected to the upper and lower arm circuits 85 for each of the multiple phases. Each of the output lines 143 is connected between the upper arm 85a and the lower arm 85b. The output lines 143 connect the upper and lower arm circuits 85 and the coils 64 for each of the multiple phases. The output lines 143 are connected to ends of the coils 64 on a side opposite to the neutral point 65.

The upper arm 85a and the lower arm 85b each include an arm switch 86 and a diode 87. The arm switch 86 is, for example, a transistor such as an MOSFET. MOSFET is an abbreviation of a metal-oxide-semiconductor field-effect transistor. The arm switch 86 is a switching element, and is capable of converting power by switching. The switch element may be a semi-conductor element such as a power element. The arm switch 86 is a conversion switch for converting electric power.

Each of the EPUs 50 includes the control circuit 160. The control circuit 160 is provided in the inverter device 80. The control circuit 160 controls driving of the inverter 81. The control circuit 160 controls driving of the motor 61 via the inverter 81. The control circuit 160 may be referred to as a motor control unit. In FIG. 2, the control circuit 160 is illustrated as CD.

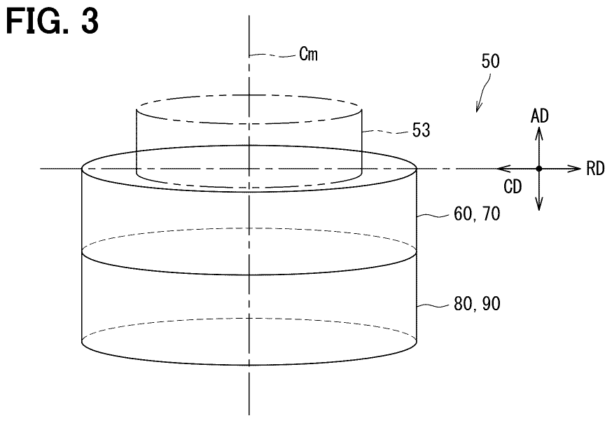

As shown in FIG. 3, in each of the EPUs 50, the motor device 60 and the inverter device 80 are arranged in an axial direction AD along a motor axis Cm. The motor device 60 is provided between a propeller 20 and the inverter device 80 in the axial direction AD. The motor axis Cm is a center axis of the motor 61 and is a virtual line extending linearly. The motor axis Cm corresponds to a rotation axis. The axial direction AD is a direction in which the motor axis Cm extends.

Regarding the motor axis Cm, the axial direction AD, a circumferential direction CD, and a radial direction RD are orthogonal to one another. The circumferential direction CD is a rotation direction of the motor 61. Regarding the radial direction RD, an outer side may be referred to as a radially outer side or an outer peripheral side, and an inner side may be referred to as a radially inner side or an inner peripheral side. The axial direction AD may be referred to as an axial direction.

Each of the EPUs 50 includes a motor housing 70 and an inverter housing 90. The motor housing 70 is included in the motor device 60. The motor housing 70 accommodates the motor 61. The inverter housing 90 is included in the inverter device 80. The inverter housing 90 accommodates the inverter 81. The motor housing 70 and the inverter housing 90 are coupled to each other.

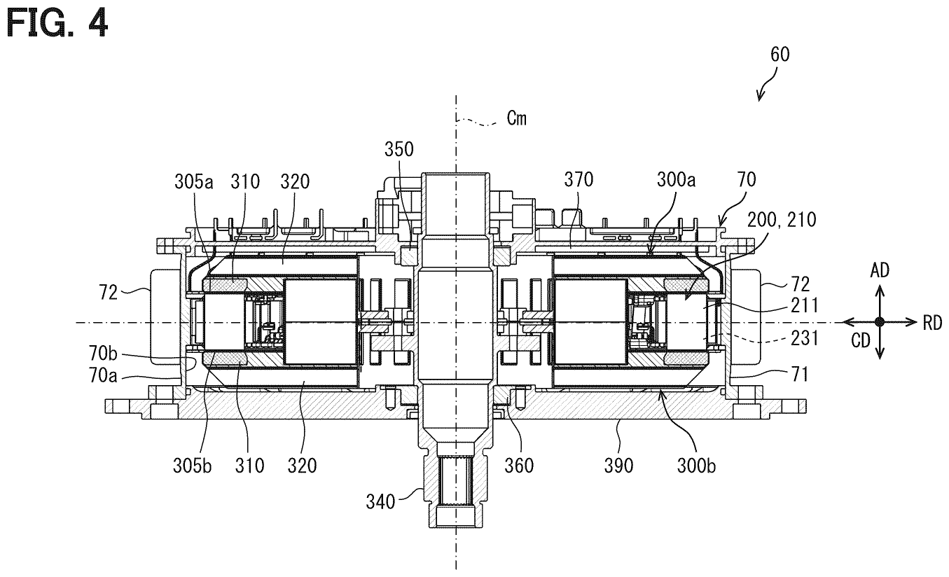

As shown in FIG. 4, the motor housing 70 includes a motor outer peripheral wall 71, a rear frame 370, and a drive frame 390. The motor outer peripheral wall 71 and the frames 370, 390 are made of a metal material or the like and have a thermal conduction property. The motor outer peripheral wall 71 is formed in a tubular shape and extends in the axial direction AD. The frames 370, 390 are formed in a plate shape and extend in a direction orthogonal to the axial direction AD. The rear frame 370 and the drive frame 390 are arranged in the axial direction AD with the motor outer peripheral wall 71 interposed therebetween. The frames 370, 390 are fixed to the motor outer peripheral wall 71 by fasteners such as bolts. FIG. 4 illustrates a vertical cross-section of the motor device 60 taken along the motor axis Cm.

The motor housing 70 has a motor-housing outer surface 70a and a motor-housing inner surface 70b. The motor-housing outer surface 70a is an outer peripheral surface of the motor housing 70 and is included in an outer surface of the motor housing 70. The motor-housing inner surface 70b is an inner peripheral surface of the motor housing 70 and is included in an inner surface of the motor housing 70. The motor-housing outer surface 70a and the motor-housing inner surface 70b are provided by the motor outer peripheral wall 71.

The rear frame 370 covers an inner space of the motor outer peripheral wall 71 and is provided between the motor outer peripheral wall 71 and the inverter device 80. The rear frame 370 is provided such that the motor outer peripheral wall 71 is between the rear frame 370 and the propeller 20. The drive frame 390 covers the inner space of the motor outer peripheral wall 71 and is provided such that the motor outer peripheral wall 71 is between the drive frame 390 and the inverter device 80. The drive frame 390 is provided between the motor outer peripheral wall 71 and the propeller 20.

The motor housing 70 includes motor fins 72. The motor fins 72 are provided on the outer surface of the motor housing 70. For example, the motor fins 72 are provided on the motor-housing outer surface 70a. The motor fins 72 extend outward from the motor outer peripheral wall 71. The motor fins 72 extend in the direction orthogonal to the circumferential direction CD. The motor fins 72 are arranged in the circumferential direction CD. The motor fins 72 are heat dissipation fins that dissipate heat of the motor device 60 to the outside.

The motor 61 includes a stator 200, a first rotor 300a, a second rotor 300b, and a shaft 340. The stator 200 is a stationary element. The stator 200 includes a coil 64. Each of the rotors 300a, 300b is a rotary element. The rotors 300a, 300b rotate relative to the stator 200. The rotors 300a, 300b rotate about the motor axis Cm. The motor axis Cm is a center axis of each of the rotors 300a, 300b. The stator 200 annularly extends in the circumferential direction CD. The motor axis Cm coincides with the center axis of the stator 200.

The motor device 60 is an axial gap rotary electric machine. The motor 61 is an axial gap motor. In the motor 61, the stator 200 and the rotors 300a, 300b are arranged in the axial direction AD along the motor axis Cm. The motor device 60 is a dual-rotor rotary electric machine. The motor 61 is a dual-rotor motor. The first rotor 300a and the second rotor 300b are arranged in the axial direction AD with the stator 200 interposed therebetween. The stator 200 is provided between two rotors, that is, the first rotor 300a and the second rotor 300b. The motor 61 of the present embodiment may be referred to as a double-axial motor.

The shaft 340 supports the rotors 300a, 300b. The shaft 340 rotates around the motor axis Cm together with the rotors 300a, 300b. A center axis of the shaft 340 coincides with the motor axis Cm. The shaft 340 connects the rotors 300a, 300b to the propeller 20.

Each of the rotors 300a, 300b includes magnet portions 310 and a magnet holder 320. The magnet portions 310 are arranged in the circumferential direction CD in each of the rotors 300a, 300b. The magnet portions 310 are arranged in the rotation direction of the rotors 300a, 300b. Two magnet portions 310 adjacent to each other in the circumferential direction CD are fixed to each other by adhesive or the like. Each of the magnet portions 310 includes a permanent magnet and forms a magnetic field. In each of the rotors 300a, 300b, the magnet portions 310 generate a magnetic flux. The magnet portions 310 of the first rotor 300a and the magnet portions 310 of the second rotor 300b are arranged in the axial direction AD with the stator 200 interposed therebetween. The magnet holder 320 supports the magnet portions 310. The magnet holder 320 defines outer and inner circumferential ends of the rotors 300a, 300b.

The stator 200 includes a coil unit 210. The coil unit 210 extends in the circumferential direction CD. The coil unit 210 forms the coils 64. The coil unit 210 includes coil portions 211 and stator cores 231. Each of the coil portions 211 is made of an electric wire or the like and conducts electricity. The coil portions 211 are wound around the stator cores 231. Each of the coil portions 211 is formed in a tubular shape as a whole and extends in the axial direction AD. Each of the stator cores 231 is an iron core and extends in the axial direction AD. The coil portions 211 and the stator cores 231 are arranged in the circumferential direction CD along the motor-housing inner surface 70b. In the coil unit 210, the coil portions 211 form the coils 64.

The motor 61 includes a first axial gap 305a and a second axial gap 305b. The axial gaps 305a, 305b are gaps between the stator 200 and the rotors 300a, 300b. The axial gaps 305a, 305b include gaps between the magnet portions 310 and the stator core 231. The axial gaps 305a, 305b extend between the stator 200 and the rotors 300a, 300b in a direction perpendicular to the axial direction AD. The first axial gap 305a is a gap between the stator 200 and the first rotor 300a. The second axial gap 305b is a gap between the stator 200 and the second rotor 300b.

The motor device 60 includes a rear bearing 350 and a drive bearing 360. The bearings 350, 360 rotatably support the shaft 340. The bearings 350, 360 annularly extend in the circumferential direction CD. The rear bearing 350 and the drive bearing 360 are arranged in the axial direction AD with the rotors 300a, 300b interposed therebetween. The bearings 350, 360 are fixed to the motor housing 70. The rear bearing 350 is fixed to the rear frame 370. The drive bearing 360 is fixed to the drive frame 390.

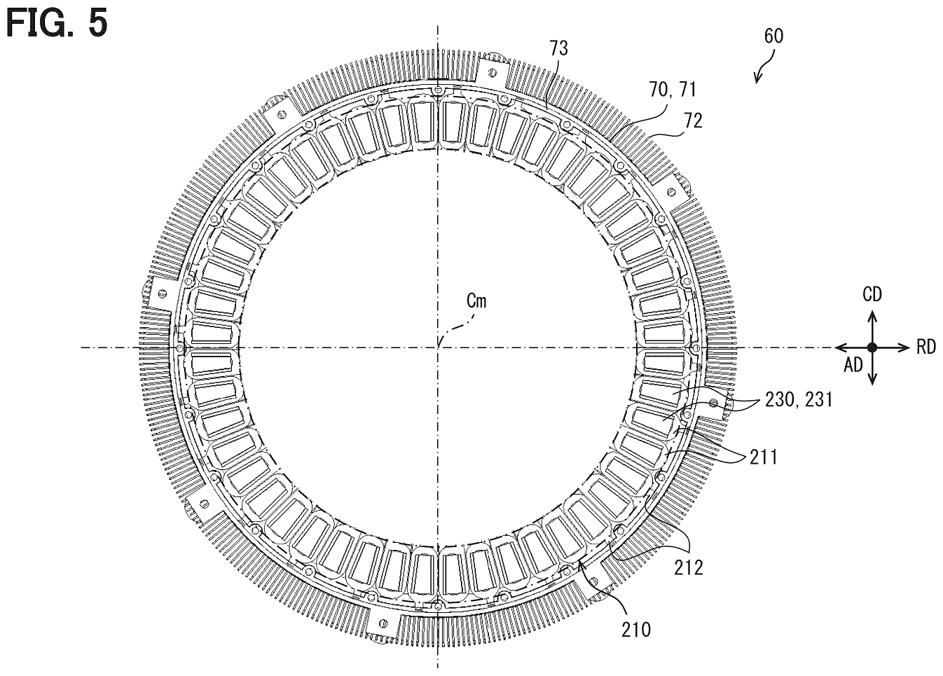

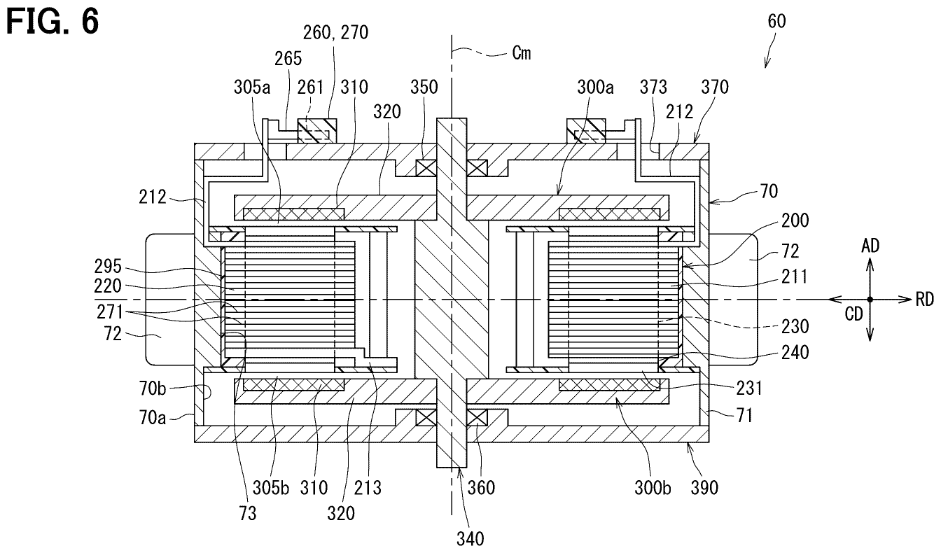

As shown in FIGS. 5 and 6, the stator 200 has core modules 230. Each of the core modules 230 has a stator core 231 and is included in the coil unit 210. The core modules 230 are arranged in the circumferential direction CD, and thus the stator cores 231 are arranged in the circumferential direction CD. Each of the core modules 230 includes a bobbin 240 in addition to the stator core 231. The bobbin 240 is made of a resin material or the like and has an electrical insulation property. The bobbin 240 has thermal conductivity. The bobbin 240 is formed in a tubular shape as a whole and extends in the axial direction AD. The bobbin 240 accommodates at least a part of the stator core 231 so as to cover an outer circumferential surface of the stator core 231. A coil portion 211 is wound around the stator core 231 via the bobbin 240.

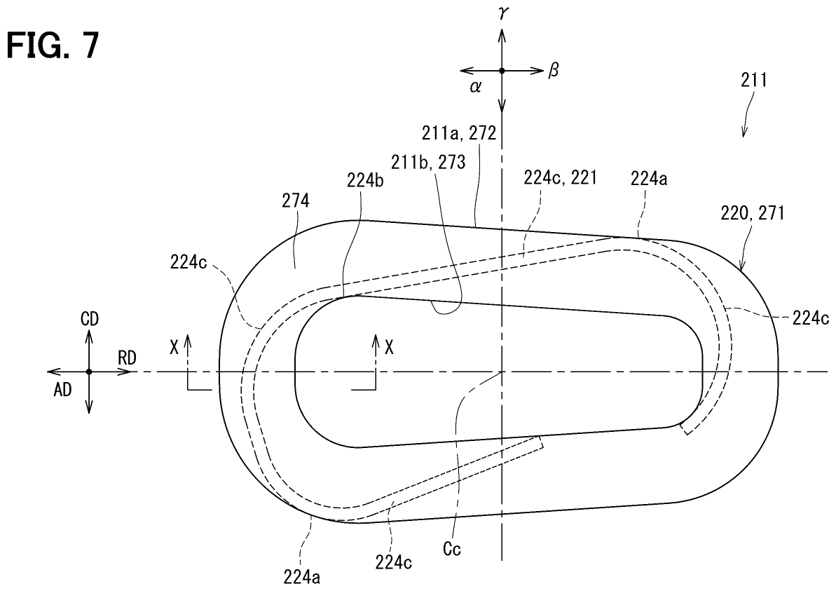

As shown in FIG. 7, a coil portion 211 extends in a coil axial direction α along the coil axis Cc. The coil axis Cc is a center axis of the coil portion 211 and is a virtual line extending linearly. The coil axial direction α is an axial direction of the coil axis Cc, and corresponds to an axial direction of the coil portion 211. With respect to the coil axis Cc, the coil axial direction α, a coil circumferential direction β, and a coil radial direction γ are perpendicular to one another. The coil circumferential direction β is a circumferential direction of the coil axis Cc and corresponds to a circumferential direction of the coil portion 211. The coil radial direction γ is a radial direction of the coil axis Cc and corresponds to a radial direction of the coil portion 211. The coil portion 211 extends annularly in the coil circumferential direction β. With respect to the coil radial direction γ, the outer side may be referred to as a radially outer side or an outer circumferential side, and the inner side may be referred to as a radially inner side or an inner circumferential side.

The coil portion 211 is provided such that the coil axial direction α coincides with the axial direction AD. The axial direction AD, the circumferential direction CD, and the radial direction RD are based on the motor axis Cm. The axial direction AD may be referred to as a motor axial direction AD, the circumferential direction CD may be referred to as a motor circumferential direction CD, and the radial direction RD may be referred to as a motor radial direction RD.

The coil portion 211 has a coil outer circumferential surface 211a and a coil inner circumferential surface 211b. The coil outer circumferential surface 211a is an outer circumferential surface of the coil portion 211. The coil inner circumferential surface 211b is an inner circumferential surface of the coil portion 211. The coil outer circumferential surface 211a and the coil inner circumferential surface 211b are included in the outer surface of the coil portion 211. The coil outer circumferential surface 211a and the coil inner circumferential surface 211b are arranged in the coil radial direction γ. The coil outer circumferential surface 211a and the coil inner circumferential surface 211b extend annularly in the coil circumferential direction β. The coil outer circumferential surface 211a and the coil inner circumferential surface 211b extend in the coil axial direction α.

As shown in FIGS. 6 and 7, the coil portion 211 includes coil annular portions 271. The coil annular portions 271 are arranged in the coil axial direction α. The coil annular portions 271 are stacked in the coil axial direction α. A coil annular portion 271 extends in a ring shape in the coil circumferential direction β. The coil annular portion 271 is formed in a plate shape as a whole, and extends in a direction perpendicular to the coil axial direction. The coil annular portion 271 has a flattened shape that has been pressed in the coil axial direction α. The coil annular portion 271 is flattened such that the width dimension in the coil radial direction γ is greater than the thickness dimension in the coil axial direction α.

The coil annular portion 271 includes an annular outer circumferential surface 272, an annular inner circumferential surface 273, and annular plate surfaces 274. The annular outer circumferential surface 272, the annular inner circumferential surface 273 and the annular plate surfaces 274 are included in the outer surface of the coil annular portion 271. The annular outer circumferential surface 272 is an outer circumferential surface of the coil annular portion 271. The annular outer circumferential surface 272 is included in the coil outer circumferential surface 211a. The annular inner circumferential surface 273 is an inner circumferential surface of the coil annular portion 271. The annular inner circumferential surface 273 is included in the coil inner circumferential surface 211b.

The annular plate surfaces 274 are plate surfaces of the coil annular portion 271. The annular plate surfaces 274 extend in a direction perpendicular to the coil axial direction α. The annular plate surfaces 274 are a pair of plate surfaces arranged in the coil axial direction α. The annular outer circumferential surface 272 and the annular inner circumferential surface 273 extend in the coil axial direction α so as to connect the pair of annular plate surfaces 274. In two coil annular portions 271 adjacent to each other in the coil axial direction α, the respective annular plate surfaces 274 are overlapped with each other.

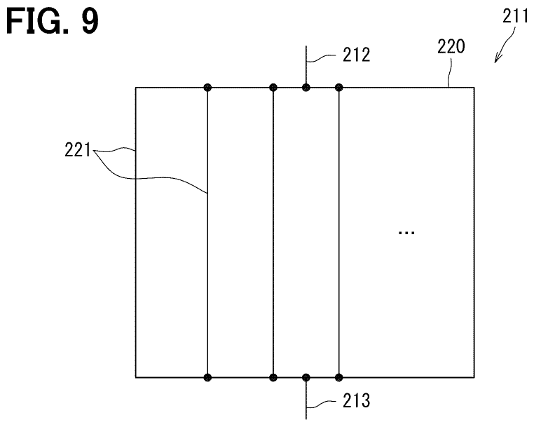

As shown in FIGS. 9, 10 and 11, the coil portion 211 includes a coil wire body 220. The coil portion 211 is formed by winding the coil wire body 220. The coil wire body 220 is wound around the core module 230. A coil wire body 220 is wound around the stator core 231 via the bobbin 240. The coil wire body 220 is wound in the coil circumferential direction β. The coil wire body 220 is wound so as to be stacked in the coil axial direction α.

The coil wire body 220 is formed into a plate shape as a whole. The coil wire body 220 has a shape similar to a rectangular wire as a whole. The coil portion 211 has a shape similar to an edgewise coil as a whole. In the coil portion 211, the coil wire body 220 extends in a direction perpendicular to the coil axial direction α.

The coil wire body 220 includes coil wires 221 as wires such as electric wires. The coil wire body 220 is formed in a wire shape by twisting the coil wires 221 together. The coil wire body 220 corresponds to a wire body. The coil wire body 220 extends in the coil circumferential direction β with the coil wires 221 twisted so as to be wound around each other. Each of the coil wires 221 is in a state of extending in the coil circumferential direction β while changing in position in a direction perpendicular to the coil circumferential direction β. In the coil wire body 220, each of the coil wires 221 changes its position in the coil circumferential direction β according to change in its position in the coil axial direction α and the coil radial direction γ.

The coil wire body 220 has a wire surface 220os. The wire surface 220os is an outer peripheral surface of the coil wire body 220. In the coil wire body 220, the wire surface 220os is formed by the coil wires 221. The coil wires 221 are exposed to the outside of the coil wire body 220, thereby forming the wire surface 220os. The coil wire body 220 does not have a coating portion that collectively covers the coil wires 221.

The coil wire body 220 forms the coil annular portions 271. The coil wire body 220 is wound multiple times to form the coil annular portions 271. The wire surface 220os is included in an outer peripheral surface of each of the coil annular portions 271. The coil wire body 220 extends in the coil radial direction γ so as to span between the annular outer circumferential surface 272 and the annular inner circumferential surface 273 in each of the coil annular portions 271. In each of the coil annular portions 271, one coil wire body 220 forms both the annular outer circumferential surface 272 and the annular inner circumferential surface 273.

The coil wire body 220 extends in the coil radial direction γ so as to span between the coil outer circumferential surface 211a and the coil inner circumferential surface 211b in the coil portion 211. In the coil portion 211, one coil wire body 220 forms both a part of the coil outer circumferential surface 211a and a part of the coil inner circumferential surface 211b. The coil wire body 220 is wound so as to be stacked in the axial direction AD toward only one side of the coil portion 211. In the coil portion 211, the coil wire body 220 is wound to form a single layer. In the coil portion 211, the coil wire body 220 is wound not to form multiple layers overlapped in the coil radial direction γ.

As shown in FIG. 7, the coil wires 221 form at least a part of the outer peripheral surface of the coil annular portion 271. The coil wires 221 are exposed to the outside of the coil annular portion 271. Each of the coil wires 221 has an outer circumferential exposed portion 224a, an inner circumferential exposed portion 224b, and a plate surface exposed portion 224c. The plate surface exposed portion 224c is a portion of a coil wire 221 that is exposed on the annular plate surface 274. The plate surface exposed portion 224c forms a part of the annular plate surface 274.

The outer circumferential exposed portion 224a is a portion of the coil wire 221 that is exposed on the annular outer circumferential surface 272. The outer circumferential exposed portion 224a forms a part of the annular outer circumferential surface 272. The outer circumferential exposed portion 224a is a portion of the coil portion 211 that is exposed on the coil outer circumferential surface 211a. The outer circumferential exposed portion 224a forms a part of the coil outer circumferential surface 211a. The outer circumferential exposed portion 224a corresponds to an outer circumference forming portion.

The inner circumferential exposed portion 224b is a portion of the coil wire 221 that is exposed on the annular inner circumferential surface 273. The inner circumferential exposed portion 224b forms a part of the annular inner circumferential surface 273. The inner circumferential exposed portion 224b is a portion of the coil portion 211 that is exposed on the coil inner circumferential surface 211b. The inner circumferential exposed portion 224b forms a part of the coil inner circumferential surface 211b. The inner circumferential exposed portion 224b corresponds to an inner circumference forming portion.

The portion of the coil wire 221 exposed on the outer surface of the coil annular portion 271 changes in position in the coil axial direction α and the coil radial direction γ when a position of the portion in the coil circumferential direction β changes. In the coil wire 221, the outer circumferential exposed portion 224a, the inner circumferential exposed portion 224b, and the plate surface exposed portion 224c are arranged in the coil circumferential direction β. In the coil circumferential direction β, the plate surface exposed portion 224c extends to connect the outer circumferential exposed portion 224a and the inner circumferential exposed portion 224b.

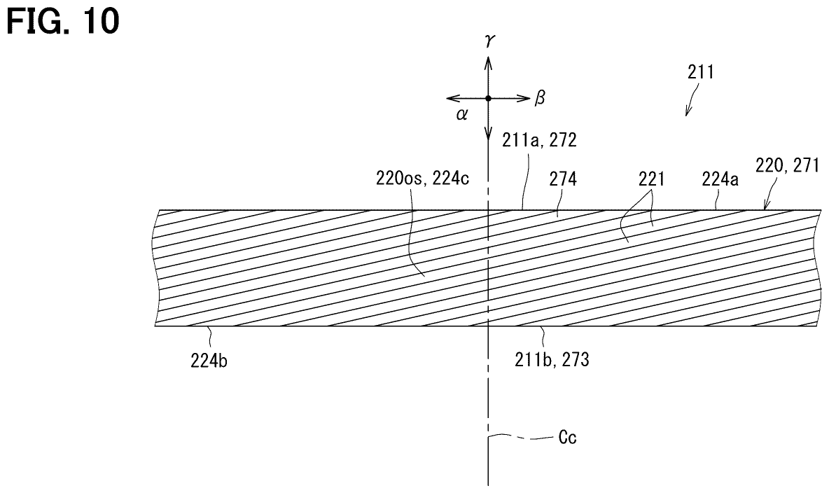

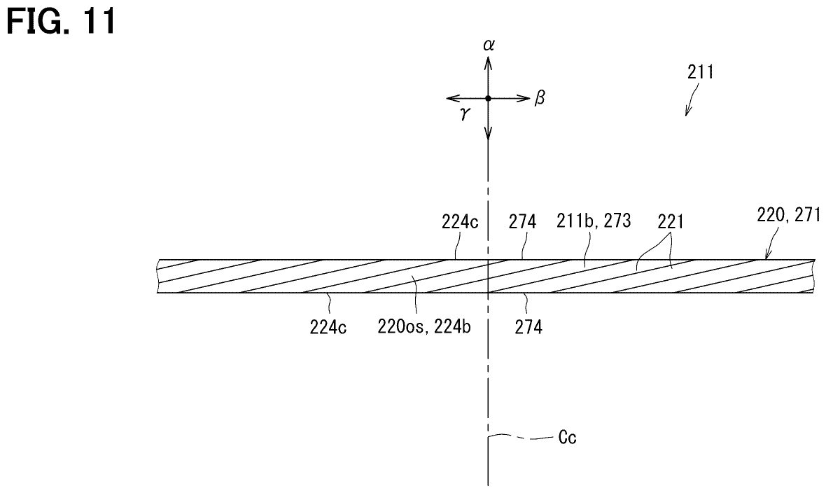

For example, as shown in FIGS. 7 and 10, the plate surface exposed portion 224c extends in the coil circumferential direction β so as to span between the outer circumferential exposed portion 224a and the inner circumferential exposed portion 224b. The plate surface exposed portion 224c extends in the coil circumferential direction β while crossing the coil wire body 220 in the coil radial direction γ. Also, as shown in FIG. 11, the outer circumferential exposed portion 224a and the inner circumferential exposed portion 224b extend in the coil circumferential direction β so as to span between the plate surface exposed portion 224c on one of the pair of annular plate surfaces 274 and the plate surface exposed portion 224c on the other of the pair of annular plate surfaces 274. The outer circumferential exposed portion 224a and the inner circumferential exposed portion 224b extend in the coil circumferential direction β while crossing the coil wire body 220 in the coil axial direction α.

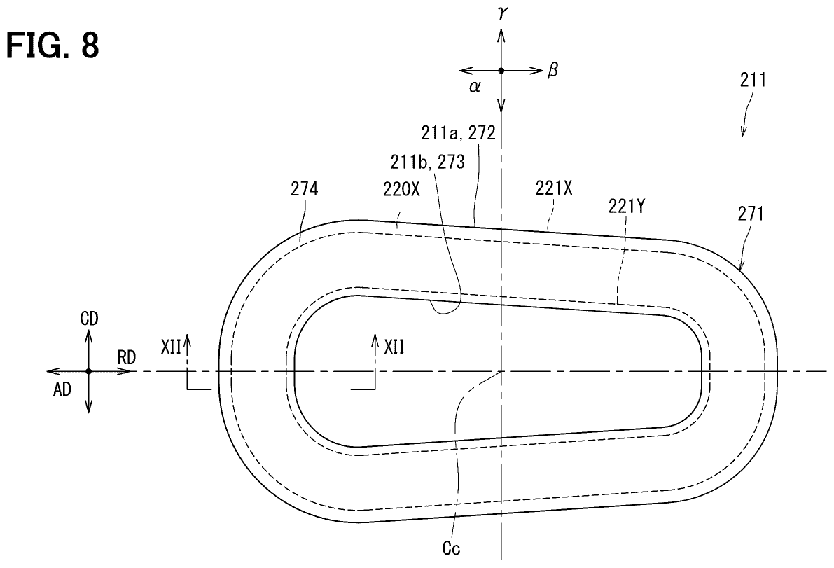

For example, a comparative wire body 220X is assumed as a comparative example, in which multiple coil wires 221 are not twisted, unlike the coil wire body 220 of the present embodiment. As shown in FIG. 8, the comparative wire body 220X forms a coil portion 211 and a coil annular portion 271. In the comparative wire body 220X, a portion of a coil wire 221 exposed on an outer surface of the coil annular portion 271 does not change in position in the coil axial direction α and the coil radial direction γ even when a position of the portion in the coil circumferential direction β changes. For example, the coil wire 221 of the comparative wire body 220X includes a comparative outer circumferential wire 221X and a comparative inner circumferential wire 221Y. The comparative outer circumferential wire 221X forms an entire annular outer circumferential surface 272 in the coil circumferential direction β. The comparative inner circumferential wire 221Y forms an entire annular inner circumferential surface 273 in the coil circumferential direction β.

In the coil annular portion 271, the comparative outer circumferential wire 221X is longer than the comparative inner circumferential wire 221Y. Therefore, when the comparative wire body 220X is wound during manufacture of the coil portion 211, the comparative outer circumferential wire 221X is stretched in the coil circumferential direction β more than the comparative inner circumferential wire 221Y. In the comparative wire body 220X, there is a concern that an excessive tensile stress may be generated in the comparative outer circumferential wire 221X, which may cause abnormalities such as breakage to easily occur in the comparative outer circumferential wire 221X.

In the coil annular portion 271, losses are more likely to occur in the areas closer to the inner circumference in the coil radial direction γ due to factors such as an increased amount of linkage magnetic flux. Therefore, loss caused by linkage magnetic flux and the like in the comparative inner circumferential wire 221Y may increase excessively. For example, if the amount of linkage magnetic flux differs between the comparative outer circumferential wire 221X and the comparative inner circumferential wire 221Y, a potential difference is likely to occur between the comparative outer circumferential wire 221X and the comparative inner circumferential wire 221Y. Furthermore, in the comparative wire body 220X, when a potential difference occurs between the comparative outer circumferential wire 221X and the comparative inner circumferential wire 221Y, a circulating current will flow between the comparative outer circumferential wire 221X and the comparative inner circumferential wire 221Y, which may result in an increase in circulating current loss. Furthermore, in the comparative wire body 220X, the linkage magnetic flux at the comparative inner circumferential wire 221Y tends to be large. Therefore, eddy current loss in the comparative inner circumferential wire 221Y may increase.

In contrast, in the coil wire body 220 of the present embodiment, each of the coil wires 221 changes its position in the coil circumferential direction β according to change in its position in the coil axial direction α and the coil radial direction γ. This can reduce the tendency for abnormalities to occur in a particular coil wire 221, such as breakage, in the comparative outer circumferential wire 221X. In addition, the tendency for loss in a particular coil wire 221 to increase excessively, as in the comparative inner circumferential wire 221Y, can be reduced.

As shown in FIG. 6, the motor device 60 includes a busbar unit 260. The busbar unit 260 extends annularly in the circumferential direction CD. The busbar unit 260 is arranged with the stator 200 in the axial direction AD. The busbar unit 260 includes an electric power busbar 261 and a busbar protection portion 270. The electric power busbar 261 and the busbar protection portion 270 extend annularly in the circumferential direction CD. The electric power busbar 261 is formed by a busbar member or the like. The electric power busbar 261 forms at least a part of the output lines 143. The busbar protection portion 270 is made of a resin material or the like and has an electrical insulation property. The busbar protection portion 270 protects the electric power busbar 261 in a state where the busbar protection portion 270 covers the electric power busbar 261.

The busbar unit 260 is fixed to the rear frame 370 by fasteners such as screws. The busbar unit 260 is provided to face the stator 200 across the rear frame 370 interposed therebetween.

In FIGS. 6 and 9, the coil unit 210 includes power lead wires 212 and neutral lead wires 213. The lead wires 212 and 213 are included in the motor device 60 and the stator 200. The lead wires 212, 213 are led out from the coil portions 211. The lead wires 212, 213 corresponds to a coil lead wire. The lead wires 212, 213 are arranged in the circumferential direction CD. The lead wires 212, 213 are formed by the coil wire body 220. The coil wire body 220 forms at least a part of the lead wires 212, 213. The power lead wires 212 form at least a part of the output lines 143. The neutral lead wires 213 form at least a part of a path connecting the coils 64 and the neutral point 65.

The power lead wires 212 electrically connects the coil portions 211 and the electric power busbar 261. The electric power lead wires 212 are connected to the electric power busbar 261 via busbar lead wires 265. The busbar lead wires 265 form at least a part of the output lines 143. The busbar lead wires 265 are formed of electric wires such as a rectangular wires, and are led out from the electric power busbar 261. The busbar lead wires 265 are included in the busbar unit 260.

The power lead wires 212 are led out to the electric power busbar 261 through rear wiring holes 373 of the rear frame 370. The rear wiring holes 373 are provided in the rear frame 370. Each of the rear wiring holes 373 penetrates the rear frame 370 in the axial direction AD. The rear wiring holes 373 are arranged in the circumferential direction CD along the outer circumference of the rear frame 370.

In the coil wire body 220, the coil wires 221 are electrically connected in parallel. The coil wires 221 are electrically connected to each other at a connection between the power lead wires 212 and the electric power busbar 261, and a connection between the neutral lead wires 213 and the neutral point 65, for example.

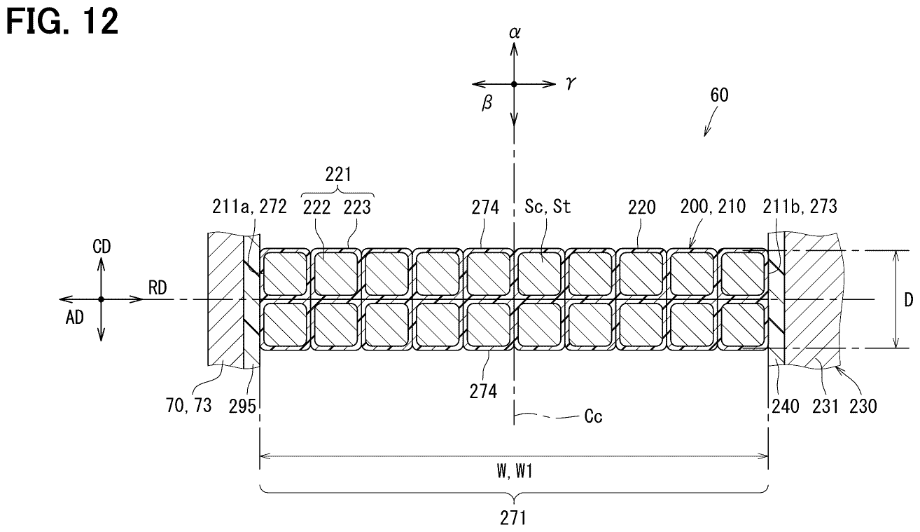

As shown in FIGS. 6 and 12, the stator 200 has a coil heat dissipation portion 295. The coil heat dissipation portion 295 is provided between each of the coil portions 211 and the motor outer peripheral wall 71. The motor outer peripheral wall 71 covers the coil portions 211 from the outer periphery side and corresponds to an electric-machine outer peripheral wall. The motor housing 70 accommodates the stator 200 and the rotors 300a, 300b, and corresponds to an electric-machine housing. The coil heat dissipation portion 295 is in surface contact with the coil wire body 220 and the coil annular portion 271 on their sides facing the motor outer peripheral wall 71. The coil heat dissipation portion 295 is capable of dissipating heat from the coil portions 211 and the coil wire body 220 to the motor outer peripheral wall 71. The coil heat dissipation portion 295 extends annularly in the circumferential direction CD along the motor-housing inner surface 70b.

The coil heat dissipation portion 295 is made of a resin material such as a thermoplastic resin, and has thermal conductivity. For example, the coil heat dissipation portion 295 has a resin layer made of a silicone-based or silicone-based resin material, and a filler made of a metal material that is mixed into the resin layer. In addition, the coil heat dissipation portion 295 may be made of a ceramic material or a metal material, or may be formed in a gel state, as long as it has thermal conductivity.

The coil heat dissipation portion 295 is in contact with the coil outer circumferential surface 211a. In the coil wire body 220, at least one coil wire 221 is in contact with the coil heat dissipation portion 295. In at least one coil wire 221, the outer circumferential exposed portion 224a is in contact with the coil heat dissipation portion 295. At the portion where the outer circumferential exposed portion 224a and the coil heat dissipation portion 295 are in contact with each other, heat of the coil portion 211 is easily transferred from the outer circumferential exposed portion 224a to the coil heat dissipation portion 295. In addition, the configuration in which the outer circumferential exposed portion 224a and the coil heat dissipation portion 295 are in contact so that heat is transferred from the outer circumferential exposed portion 224a to the coil heat dissipation portion 295 also includes a configuration in which there is a gap or a separate member between the outer circumferential exposed portion 224a and the coil heat dissipation portion 295.

The motor housing 70 includes an inner wall protrusion 73. The inner wall protrusion 73 is a protrusion provided on the motor-housing inner surface 70b. The inner wall protrusion 73 protrudes radially inward from the motor outer peripheral wall 71. The inner wall protrusion 73 extends annularly in the circumferential direction CD. The coil heat dissipation portion 295 is provided between each of the coil portions 211 and the inner wall protrusion 73 of the motor outer peripheral wall 71. The coil heat dissipation portion 295 is capable of dissipating heat from the coil portions 211 to the motor outer peripheral wall 71 through the inner wall protrusion 73.

As shown in FIG. 12, the coil wire body 220 has a flattened shape that has been pressed in the coil axial direction α. In the coil wire body 220, a width dimension W in the coil radial direction γ is larger than a thickness dimension D in the coil axial direction α. The width dimension W is the same as the width dimension W1 of the coil portion 211. The width dimension W1 is the distance between the coil outer circumferential surface 211a and the coil inner circumferential surface 211b in the coil radial direction γ. In the coil wire body 220, the number of coil wires 221 arranged in the coil radial direction γ is greater than the number of coil wires 221 arranged in the coil axial direction α. For example, three or more coil wires 221 are arranged in two rows in the coil radial direction γ.

Each of the coil wires 221 includes a coil bare wire 222 and a wire coating 223. The coil bare wire 222 is a conductor of the coil wire 221. The coil bare wire 222 is made of a conductive material such as copper, and has a conduction property. The coil bare wire 222 is electrically conductive and corresponds to a bare wire. The coil bare wire 222 may be formed of a single conductor or a plurality of conductors. The wire coating 223 covers the coil bare wire 222. The wire coating 223 is made of a resin material or the like, and has an electrical insulation property. The wire coating 223 corresponds to a coating portion. The wire coating 223 is sometimes referred to as an insulating coating.

In the coil wire body 220, the cross-sectional shape and thickness of the coil wires 221 are uniform among the multiple coil wires 221. The cross-sectional areas of the coil wires 221 are approximately the same for each of the multiple coil wires 221. The cross-sectional areas Sc of the coil bare wires 222 are substantially the same for the multiple coil wires 221. The cross-sectional area Sc is an area of a cross section of a coil bare wire 222 perpendicular to the coil circumferential direction β. In the coil wire body 220, the cross-sectional area Sc of the coil wire 221 tends to be smaller toward the outer periphery in the coil radial direction γ. The total cross-sectional area St of the coil wire body 220 is the sum of the cross-sectional areas Sc of the coil bare wires 222 over the multiple coil wires 221. The total cross-sectional area St is the sum of the cross-sectional areas of the conductor coil bare wires 222 over the multiple coil wires 221.

In the coil wire body 220, the coil wires 221 are in surface contact with each other. For example, the wire coatings 223 of two coil wires 221 adjacent to each other in a direction perpendicular to the coil circumferential direction β are in surface contact with each other. In the coil wires 221, the wire coatings 223 are joined by fusion or welding. These wire coatings 223 are in contact with each other. For example, in two portions of the coil wire body 220 adjacent to each other in a direction perpendicular to the coil circumferential direction β, at least portions of the wire coatings 223 are joined. In addition, a gap may be provided between these two portions of the coil wire body 220.

In the coil wire body 220, the coil wires 221 are twisted while being rolled so that they are in surface contact with each other. For example, in the coil wire body 220, the cross-sectional shape of a coil wire 221 changes as the coil wire body 220 is rolled. For example, the outer circumferential surface of the coil bare wire 222 includes a flat surface extending in a direction perpendicular to the coil radial direction γ and the coil axial direction α. This flat surface is a surface formed by deformation of the coil bare wire 222 due to the rolling of the coil wire body 220. By rolling the coil wire body 220, the space factor of the coil portion 211 is increased. The space factor is the ratio occupied by coil bare wires 222 in the cross section of the coil portion 211. The space factor is sometimes referred to as a conductor space factor.

According to the present embodiment described above, the coil wire body 220 constituting the coil portion 211 is formed into a wire shape by twisting the coil wires 221 together. In this configuration, when the position in the coil circumferential direction β changes, the coil wires 221 are shifted inward of the coil portion 211 one by one while being switched in position. Therefore, it is possible to avoid an increase in loss in a particular coil wire 221 arranged on the inner side of the coil portion 211, such as an increase in loss in the comparative inner circumferential wire 221Y. Therefore, the loss in the coil portion 211 can be reduced.

Moreover, the wire surface 220os is formed by the multiple coil wires 221. In this configuration, there is no need to provide the coil wire body 220 with a coating that collectively covers the multiple coil wires 221. Therefore, since there is no coating that covers the multiple coil wires 221, the space factor of the coil portion 211 can be increased. Therefore, the loss in the coil portion 211 can be further reduced.

In the coil annular portion 271, the conductor portion of the coil wire body 220 is divided into the multiple coil bare wires 222. In this configuration, the cross-sectional area of one conductor, the coil bare wire 222, is reduced, so that the area in which eddy currents occur in the one conductor can be reduced. Therefore, eddy current losses generated in the conductor portion of the coil annular portion 271 by the alternating magnetic flux and armature magnetic flux can be reduced.

In the coil annular portion 271, since the coil wires 221 are twisted, the linkage magnetic flux can be prevented from interlinking only with a particular coil wire 221 such as the comparative inner circumferential wire 221Y. For example, in a coil wire 221, the linkage magnetic flux is likely to increase at the inner circumferential exposed portion 224b, and the linkage magnetic flux is likely to decrease at the outer circumferential exposed portion 224a. Therefore, since the coil wire 221 includes a portion where the distance from the stator core 231 is increased in the coil radial direction γ, such as the outer circumferential exposed portion 224a, eddy current losses throughout the entire coil wire 221 can be reduced.

In addition, in the coil annular portion 271, the linkage magnetic flux at one of the pair of annular plate surfaces 274 opposite the axial gaps 305a, 305b tends to be less than the linkage magnetic flux at the annular plate surface 274 facing the axial gaps 305a, 305b. Therefore, since the coil wire 221 includes the plate surface exposed portion 224c opposite the axial gaps 305a, 305b, eddy current losses throughout the entire coil wire 221 can be reduced. That is, by twisting the coil wires 221, the coil wires 221 are partially separated from the axial gaps 305a, 305b, thereby reducing eddy current losses in the coil wires 221.

In the present embodiment, since the coil wires 221 are twisted in the coil annular portion 271, generation of circulating current in the coil wires 221 can be reduced. For example, in the comparative wire body 220X, the difference between the length dimension of the comparative outer circumferential wire 221X and the length dimension of the comparative inner circumferential wire 221Y in the coil annular portion 271 is too large. When the length of the comparative outer circumferential wire 221X and the length of the comparative inner circumferential wire 221Y are largely different, the difference between the electrical resistance of the comparative outer circumferential wire 221X and the electrical resistance of the comparative inner circumferential wire 221Y is likely to become large. In that case, a circulating current caused by the resistance difference may circulates between the comparative outer circumferential wire 221X and the comparative inner circumferential wire 221Y.

In contrast, in the present embodiment, since the multiple coil wires 221 are twisted in the coil annular portion 271, differences in length are unlikely to occur among these coil wires 221. In other words, differences in electrical resistance are unlikely to occur among the multiple coil wires 221. Therefore, a circulating current flowing through the coil wires 221 due to differences in electrical resistance can be reduced.

According to the present embodiment, in the coil wire body 220, the number of coil wires 221 arranged in the coil radial direction γ is greater than the number of coil wires 221 arranged in the coil axial direction α. In this configuration, the coil wire body 220 can be formed into a plate shape using the coil wires 221. By forming the coil wire body 220 in a plate shape in this manner, the space factor of the coil portion 211 can be increased.

According to the present embodiment, in the coil annular portion 271, the width dimension W in the coil radial direction γ is larger than the thickness dimension D in the coil axial direction α. In this configuration, the coil portion 211 can be formed like an edgewise coil by the coil annular portion 271, so that the space factor of the coil portion 211 can be increased.

For example, unlike the present embodiment, a configuration is assumed in which the coil wire body 220 is wound in the coil portion 211 to form multiple layers in the coil radial direction γ. In this configuration, the potential difference between two layers adjacent to each other in the coil radial direction γ tends to become large. Thus, when attempting to electrically insulate the two layers adjacent in the coil radial direction γ, the insulating coating of the coil wire body 220 must be made thicker. Furthermore, the thicker the insulating coating of the coil wire body 220, the lower the space factor of the coil portion 211 becomes.

In contrast, according to the present embodiment, the coil wire body 220 extends in the coil radial direction γ so as to span between the coil outer circumferential surface 211a and the coil inner circumferential surface 211b so as to form both the coil outer circumferential surface 211a and the coil inner circumferential surface 211b. In this configuration, the coil wire body 220 is wound in a single layer around the coil portion 211. That is, the coil portion 211 does not have two layers adjacent to each other in the coil radial direction γ. In this way, since there is no need to electrically insulate two layers adjacent to each other in the coil radial direction γ, the insulating coating of the coil wire body 220 can be made as thin as possible. Therefore, there is no need to provide the coil wire body 220 with a coating portion that collectively covers the multiple coil wires 221. Furthermore, the wire coating 223 of the coil wire body 220 can be made as thin as possible. By making the insulating coating of the coil wire body 220 as thin as possible in this way, the space factor of the coil portion 211 can be increased. The thickness of the wire coating 223 is made as thin as possible, for example, 10 μm or more.

In the coil portion 211, a potential difference is generated between two coil annular portions 271 adjacent to each other in the coil axial direction α. This potential difference is small enough that the wire coating 223 can electrically insulate the two coil annular portions 271. In the coil wire body 220, each of the multiple coil wires 221 has the wire coating 223, and each of the coil bare wires 222 is electrically insulated by the wire coating 223. Therefore, the wire coating 223 can prevent eddy currents from flowing across the multiple coil bare wires 222. Therefore, the eddy current losses in the coil wire body 220 can be reduced.

The thickness of the wire coating 223 required for reducing eddy current losses is, for example, about 4 μm. The thickness of the wire coating 223 required for electrically insulating the two coil annular portions 271 adjacent to each other in the coil axial direction α is, for example, about 2 to 5 μm. In this embodiment, the thickness of the wire coating 223 is greater than both the thickness required to reduce eddy current losses and the thickness required to electrically insulate the two coil annular portions 271. Therefore, in the coil portion 211, the wire coating 223 can achieve both reduction in eddy current losses and electrical insulation between the two coil annular portions 271.

According to this embodiment, in the coil wire body 220, the coil wires 221 are twisted together so that a coil wire 221 have both the outer circumferential exposed portion 224a and the inner circumferential exposed portion 224b. In this configuration, the coil wire 221 extends in the coil circumferential direction β while being shifted in a direction perpendicular to the coil circumferential direction β, so that differences in wire length between the multiple coil wires 221 can be reduced. Therefore, in the multiple coil wires 221, a circulating current caused by a difference in electrical resistance due to a difference in wire length can be reduced.

In the present embodiment, the coil annular portions 271 are in surface contact with the coil heat dissipation portion 295. Therefore, the effect of dissipating heat from the coil annular portions 271 to the motor outer peripheral wall 71 can be improved by the coil heat dissipation portion 295. Moreover, the coil wires 221 are twisted together so that the coil wires 221 have the outer circumferential exposed portion 224a. Therefore, in the coil annular portion 271, the outer circumferential exposed portion 224a can be in surface contact with the coil heat dissipation portion 295 for each of the multiple coil wires 221. Therefore, the heat dissipation effect of the outer circumferential exposed portion 224a can be enhanced by the coil heat dissipation portion 295 for each of the multiple coil wires 221.

The temperature of the coil portion 211 may become higher in the coil radial direction γ toward the coil inner circumferential surface 211b. That is, the temperature of the coil wire body 220 may become higher in a direction toward the inner circumferential exposed portion 224b. For example, in the inner circumferential exposed portion 224b, loss due to linkage magnetic flux and the like is likely to increase, and heat is likely to be generated. In addition, heat from the stator core 231 is likely to be transferred to the inner circumferential exposed portion 224b.

In contrast, in the present embodiment, the outer circumferential exposed portion 224a and the inner circumferential exposed portion 224b of a coil wire 221 are connected by the plate surface exposed portion 224c. In this configuration, heat from the inner circumferential exposed portion 224b is easily dissipated from the outer circumferential exposed portion 224a to the outside of the coil portion 211 via the plate surface exposed portion 224c. This prevents heat from the inner circumferential exposed portion 224b from being trapped in a portion close to the coil inner circumferential surface 211b, and prevents the temperature of the coil portion 211 from becoming excessively high. Therefore, the heat dissipation effect of the coil portion 211 can be improved by the coil wire body 220.

For example, in the comparative wire body 220X shown in FIG. 8, in order for the heat of the comparative inner circumferential wire 221Y to be released from the comparative outer circumferential wire 221X, this heat must be transmitted through the multiple coil wires 221 outward in the coil radial direction γ. This heat is transferred from one of the coil bare wires 222 to the other of the coil bare wires 222 through the wire coating 223 or air in two coil wires 221 adjacent to each other in the coil radial direction γ. Since the wire coating 223 and air have relatively high thermal resistance, heat from the comparative inner circumferential wire 221Y is unlikely to be transmitted to the comparative outer circumferential wire 221X.

In contrast, in the present embodiment, one coil wire body 220 is exposed on both the coil inner circumferential surface 211b and the coil outer circumferential surface 211a. In the coil wire body 220, heat from the inner circumferential exposed portion 224b is transferred via the coil bare wires 222 to the outer circumferential exposed portion 224a. The thermal resistance of the coil bare wires 222 is lower than that of the wire coating 223 and air. Therefore, heat from the inner circumferential exposed portion 224b is easily transferred to the outer circumferential exposed portion 224a. In this manner, since the coil wire body 220 has both the outer circumferential exposed portion 224a and the inner circumferential exposed portion 224b, the heat dissipation effect of the coil portion 211 can be improved.

According to the present embodiment, in at least one coil wire 221, the outer circumferential exposed portion 224a is in contact with the coil heat dissipation portion 295 so that heat from the coil portion 211 is dissipated from the outer circumferential exposed portion 224a to the coil heat dissipation portion 295. In this configuration, heat from the outer circumferential exposed portion 224a is easily dissipated to the motor outer peripheral wall 71 through the coil heat dissipation portion 295. Therefore, the effect of dissipating heat from the coil wire body 220 to the motor outer peripheral wall 71 can be improved by the coil heat dissipation portion 295. For example, in the coil wire body 220, when heat from the inner circumferential exposed portion 224b is transferred to the outer circumferential exposed portion 224a via the plate surface exposed portion 224c, this heat is likely to be dissipated to the outside from the motor outer peripheral wall 71 via the coil heat dissipation portion 295.

According to the present embodiment, the power lead wires 212 and the neutral lead wires 213 are provided by the coil wire body 220. Therefore, the coil wire body 220 can reduce losses occurring in the power lead wires 212 and the neutral lead wires 213 due to differences in wire lengths of the coil wires 221.

According to the present embodiment, in the coil wire body 220, the coil wires 221 are twisted together such that two adjacent coil wires 221 in a direction perpendicular to the coil circumferential direction β are in surface contact with each other via their respective wire coatings 223. In this configuration, since the coil wire body 220 is in a rolled state, the space factor of the coil portion 211 can be increased.

In the axial gap type motor 61, the coil portions 211, the stator core 231, and the rotors 300a, 300b are arranged in the axial direction AD, which tends to increase leakage magnetic flux toward the coil portions 211. Moreover, in the double-rotor motor 61, leakage magnetic flux occurs from both sides of the motor 61 in the axial direction AD, which tends to increase leakage magnetic flux toward the coil portions 211. In contrast, according to the present embodiment, the flow of circulating current in the coil wires 221 due to the difference in linkage magnetic flux is reduced, which is effective for a double axial motor.

According to the present embodiment, the motor device 60 drives the eVTOL 10 to fly. In this configuration, when the eVTOL 10 is flying due to the drive of motor device 60, loses in the coil portions 211 can be reduced. In this way, the safety of the eVTOL 10 can be improved by reducing losses in the coil portions 211 in the motor device 60.

### Second Embodiment

In the first embodiment, the coil wires 221 in the coil wire body 220 are directly joined in contact with each other. In contrast, in the second embodiment, multiple coil wires 221 are indirectly joined together. Configurations, operations, and effects not specifically described in the second embodiment are the same as those in the above-described first embodiment. In the second embodiment, differences from the above-described first embodiment will be mainly described.

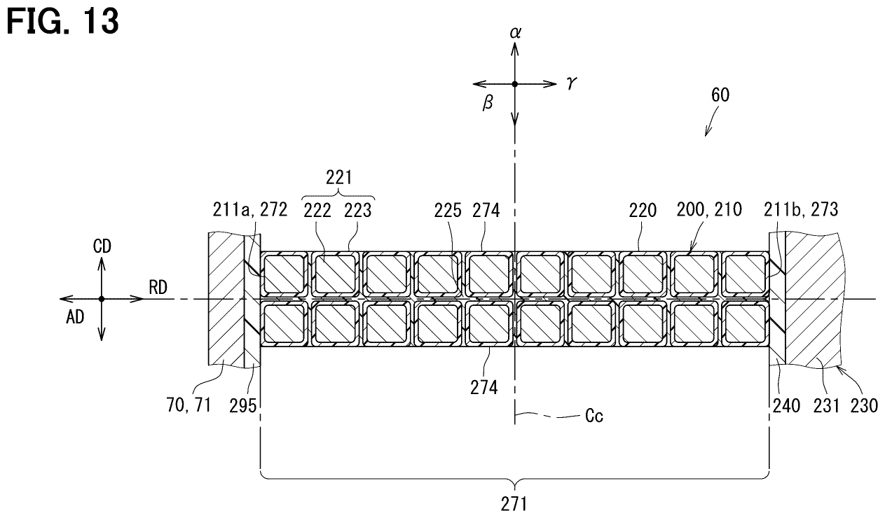

As shown in FIG. 13, a coil wire body 220 has a wire fused portion 225. The wire fused portion 225 is provided between the coil wires 221 and fuse the coil wires 221 together. For example, the wire fused portion 225 is provided between two adjacent coil wires 221 in a direction perpendicular to the coil circumferential direction β, and joins these coil wires 221 by fusion. The wire fused portion 225 corresponds to a joint portion. The wire fused portion 225 fuses the wire coatings 223 of the multiple coil wires 221. The wire fused portion 225 is formed by solidifying a fusion material, and has thermal conductivity. The fusion material is made of a resin material or the like.

In addition, as long as the wire fused portion 225 fuses two adjacent coil wires 221 together, it is not necessary for the wire fused portion 225 to extend between these coil wires 221. Furthermore, the wire fused portion 225 may join two adjacent coil wires 221 by welding or adhesion.

In the coil wire body 220, the gaps between the multiple coil wires 221 are filled with wire fused portion 225. In addition, the wire fused portion 225 may have gaps or spaces such as voids. For example, between two adjacent coil wires 221 in a direction perpendicular to the coil circumferential direction β, a gap may occur between a wire fused portion 225 on one coil wire 221 and a wire fused portion 225 on the other coil wire 221.

According to the present embodiment, the wire fused portion 225 is provided between two adjacent coil wires 221 in a direction perpendicular to the coil circumferential direction β, and fuses these coil wires 221 together. In this configuration, the gap between two adjacent coil wires 221 can be filled with the wire fused portion 225, making it easier for heat to be transferred between these coil wires 221. Therefore, heat from the stator core 231 and the coil wire 221 is easily transferred from the coil wire body 220 to the coil heat dissipation portion 295. Therefore, the heat dissipation effect of the motor device 60 can be enhanced by the wire fused portions 225.

### Third Embodiment

In the first embodiment, the coil wires 221 in the coil wire body 220 are in surface contact with each other. In contrast to this, in the third embodiment, the multiple coil wires 221 do not need to be in surface contact with each other. Configurations, operations, and effects not specifically described in the third embodiment are the same as those in the above-described first embodiment. In the third embodiment, differences from the above-described first embodiment will be mainly described.

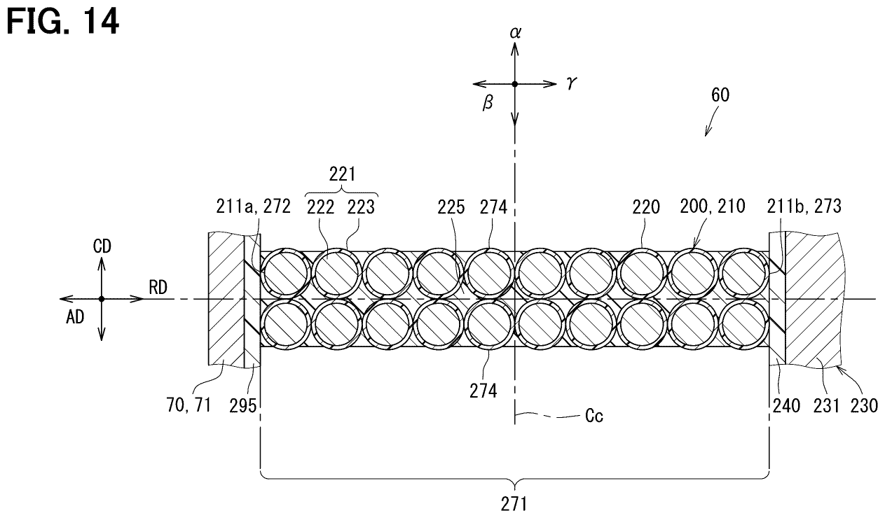

In FIG. 14, a coil wire body 220 includes coil wires 221 that are twisted together without being rolled. In the coil wire body 220, the cross-sectional shape of each coil wire 221 is a shape that is obtained without rolling of the coil wire body 220. For example, the cross-sectional shape of each coil wire 221 is circular and does not have any flat surfaces. In this embodiment, similarly to the second embodiment, the coil wires 221 in the coil wire body 220 are joined by a wire fused portion 225.

### OTHER EMBODIMENTS

The disclosure of this specification is not limited to the illustrated embodiment. The disclosure encompasses the illustrated embodiments and variations based on the embodiments by those skilled in the art. For example, the disclosure is not limited to the combinations of components and elements shown in the embodiments, and various modifications and implementations can be performed. The disclosure may be implemented in various combinations. The disclosure may have additional portions that may be added to the embodiments. The disclosure encompasses the embodiments in which parts and elements are omitted. The disclosure encompasses replacement or combination of the components and elements between one embodiment and another. The technical scope disclosed in the present disclosure is not limited to the above-described embodiments. It should be understood that some disclosed technical ranges are indicated by description of claims, and includes every modification within the equivalent meaning and the scope of description of claims.

In each of the above-described embodiments, as long as the coil wire body 220 is formed by twisting the multiple coil wires 221, the coil wires 221 may be twisted in any manner. In the coil wire body 220, the multiple coil wires 221 may be twisted such that multiple layers overlap in the radial direction of the coil wire body 220. For example, in the coil wire body 220, an inner layer and an outer layer may be arranged in the radial direction of the coil wire body 220. The inner layer has multiple coil wires 221. In the inner layer, the multiple coil wires 221 are twisted. The outer layer has multiple coil wires 221 that are different from those of the inner layer. In the outer layer, the coil wires 221 are twisted to cover the inner layer. The coil wires 221 included in the inner layer do not have the outer circumferential exposed portion 224a, the inner circumferential exposed portion 224b, and the plate surface exposed portion 224c.

In each of the above-described embodiments, as long as the coil wires 221 are twisted together in the coil wire body 220, the coil wires 221 may have any configuration. For example, in the coil wire body 220, the cross-sectional shape, thickness, etc. of the coil wires 221 may differ among the multiple coil wires 221. For example, the cross-sectional areas of the coil wires 221 may differ among the multiple coil wires 221.

In each of the above-described embodiments, the coil wire body 220 may be wound in any manner as long as it forms the coil portion 211. For example, the coil wire body 220 may be wound in multiple layers overlapped in the coil radial direction γ in the coil portion 211. The coil wire body 220 may be wound twice in the coil radial direction γ. Furthermore, the coil wire body 220 does not have to be stacked in the coil axial direction α.

In each of the above-described embodiments, the coil wire body 220 only needs to form at least a part of the coil portion 211. For example, in the coil portion 211, it is sufficient that at least a portion of the coil annular portion 271 is formed by the coil wire body 220. In this configuration, the remaining coil annular portion 271 may be formed of an electric wire or the like in which the multiple coil wires 221 are not twisted.

In each of the above-described embodiments, the coil wire body 220 may form at least a part of a coil lead wire such as the power lead wires 212. Furthermore, the coil wire body 220 does not necessarily have to have a coil lead wire.

In each of the embodiments described above, the motor 61 may not be a dual-rotor motor. For example, the motor 61 may be a single-rotor motor.

In each of the embodiments described above, the flight vehicle on which the motor device 60 is mounted may not be the vertical take-off and landing aircraft as long as being of an electric type. For example, the flight vehicle may be a flight vehicle capable of taking off and landing while gliding, as an example of the electric aircraft. The flight vehicle may be a rotorcraft, or a fixed-wing aircraft. The flight vehicle may be an unmanned flight vehicle carrying no person.

In each of the embodiments described above, the moving object on which the motor device 60 is mounted may not be a flight vehicle as long as the moving object is movable by rotation of the rotary body. For example, the moving object may be a vehicle, a ship, a construction machine, or an agricultural machine. For example, when the moving object is a vehicle, a construction machine, or the like, the rotary body is a movement-wheel or the like, and an output shaft portion is an axle or the like. When the moving object is a ship, the rotary body is a propulsion-screw propeller or the like, and the output shaft portion is a propeller shaft or the like. Furthermore, the motor device 60 may be provided in various types of stationary equipment.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A rotary electric machine configured to be driven by a supply of electric power, the rotary electric machine comprising:
a stator including a coil portion having coil wires; and
a rotor configured to rotate about a rotation axis, wherein
the coil portion includes a wire body that
has a wire shape in which the coil wires are twisted together, and
has an outer peripheral surface formed by the coil wires,
the wire body
extends in a radial direction of the coil portion,
spans between an outer circumferential surface and an inner circumferential surface of the coil portion, and
forms both the outer circumferential surface and the inner circumferential surface of the coil portion.

2. The rotary electric machine according to claim 1, wherein
the coil wires of the wire body are arranged such that number of coil wires arranged in a radial direction of the coil portion is greater than number of coil wires arranged in an axial direction of the coil portion.

3. The rotary electric machine according to claim 1, wherein
the wire body has a flattened shape in which a width dimension of the wire body in a radial direction of the coil portion is greater than a thickness dimension of the wire body in an axial direction of the coil portion.

4. The rotary electric machine according to claim 1, wherein
the coil wires of the wire body are twisted such that a coil wire has both an outer circumference forming portion that forms an outer circumferential surface of the coil portion and an inner circumference forming portion that forms an inner circumferential surface of the coil portion.

5. The rotary electric machine according to claim 4, further comprising
an electric-machine housing having an electric-machine outer peripheral wall covering a circumferentially outer side of the coil portion and housing the stator and the rotor; and
a coil heat dissipation portion provided between the electric-machine outer peripheral wall and the coil portion and configured to dissipate heat of the coil portion to the electric-machine outer peripheral wall, wherein
in at least one of the coil wires, the outer circumference forming portion is in contact with the coil heat dissipation portion to allow heat of the coil portion to be dissipated from the outer circumference forming portion to the coil heat dissipation portion.

6. The rotary electric machine according to claim 1, wherein
the stator includes a coil lead wire formed by the wire body and lead out from the coil portion.

7. The rotary electric machine according to claim 1, wherein
each of the coil wires includes
a bare wire that is an electrical conductor, and
a coating portion having an electrical insulation property and coating the bare wire,
the coil wires of the wire body have two coil wires adjacent to each other in a direction perpendicular to a circumferential direction of the coil portion, and
the two coil wires are in surface contact with each other on their respective coating portions.

8. The rotary electric machine according to claim 1, wherein
the coil portion includes a joint provided between two coil wires adjacent to each other in a direction perpendicular to a circumferential direction of the coil portion, and
the joint joins the two coil wires.

9. The rotary electric machine according to claim 1, wherein
the rotor is a first rotor, and
the rotary electric machine further comprises a second rotor facing the first rotor through the coil portion along the rotation axis.

10. The rotary electric machine according to claim 1, wherein
the rotary electric machine is provided in a flight vehicle and drives the flight vehicle to fly.

11. A rotary electric machine configured to be driven by a supply of electric power, the rotary electric machine comprising:
a stator including a coil portion having coil wires;
a rotor configured to rotate about a rotation axis;
an electric-machine housing having an electric-machine outer peripheral wall covering a circumferentially outer side of the coil portion and housing the stator and the rotor; and
a coil heat dissipation portion provided between the electric-machine outer peripheral wall and the coil portion and configured to dissipate heat of the coil portion to the electric-machine outer peripheral wall, wherein
the coil portion includes a wire body that
has a wire shape in which the coil wires are twisted together, and
has an outer peripheral surface formed by the coil wires,
in at least one of the coil wires, the outer circumference forming portion is in contact with the coil heat dissipation portion to allow heat of the coil portion to be dissipated from the outer circumference forming portion to the coil heat dissipation portion, and
the stator includes a coil lead wire formed by the wire body and lead out from the coil portion.
